(19) United States
(12) Patent Application Publication
(10) Pub. No.: US 2020/0167450 A1
(43) Pub. Date: May 28, 2020

(54) IDENTITY AUTHENTICATION METHOD AND SYSTEM

(71) Applicant: TENDYRON CORPORATION, BEIJING (CN)

(72) Inventor: Ming LI, Beijing (CN)

(73) Assignee: TENDYRON CORPORATION, BEIJING (CN)

(21) Appl. No.: 16/083,273

(22) PCT Filed: Mar. 6, 2017
(86) PCT No.: PCT/CN2017/075725

§ 371 Date: Sep. 7, 2018

(30) Foreign Application Priority Data
Mar. 7, 2016 (CN) 201610127887.X

(51) Int. Cl. G06F 21/32; H04L 29/06; H04W 12/06; H04L 9/32

(52) U.S. Cl. CPC G06F 21/32; H04L 63/126; H04W 12/0602; H04L 9/3255; H04L 63/0861; H04L 63/0876; H04L 63/083

(57) ABSTRACT

An identity authentication method and system. The method comprises: a first device establishing a communication connection with a second device; the first device receiving data to be authenticated, transmitted by the second device, via the communication connection; the first device collecting biological characteristic information about a biological limb; the first device sending the data to be authenticated and the biological characteristic information to a background server; the background server receiving the data to be authenticated and the biological characteristic information; the background server acquiring a pre-stored authentication factor and biological characteristic authentication information corresponding to an identity identification; and under the condition that authentication performed on the digital authentication information is passed and a matching rate between the biological characteristic information and the biological characteristic authentication information is greater than a first pre-set value, determining that the identity authentication for the second device is passed.

### CROSS-REFERENCE TO RELATED APPLICATION

This application is a US national phase application of International Application No. PCT/CN2017/075725, filed on Mar. 6, 2017, which claims priority to and benefits of Chinese Patent Application Serial No. 201610127887.X, filed with the State Intellectual Property Office of P. R. China on Mar. 7, 2016, the entire content of which is incorporated herein by reference.

### FIELD

The present disclosure relates to a field of electronic technology, and in particular, to an identity authentication method and an identity authentication system.

### BACKGROUND

When a user uses an electronic device to obtain authorization for certain specific places (e.g., office areas, confidential areas, etc.), personal items (cars, safes, etc.), dangerous goods (such as firearms, ammunition, etc.), a communication connection is established between the electronic device and electronic systems configured on the places, personal belongings or dangerous goods, and then the electronic device sends a stored key to the electronic system, and the electronic system performs an authentication on the key. It can be seen that in the prior art, such an authorization method allows others to use other people's electronic devices to obtain authorization to perform illegal operations, resulting in loss of property, information etc. of the user.

In addition, in the prior art, since the probability of different people having a same biological character such as fingerprint is very small, biological characters are usually used as a password for the user. In this application, in order to protect the security of the user, when verifying the biological characteristic information, the matching rate is set relative high to avoid the user's account being illegally used, but in this case, since the user's biological characters collected in different states may have slight differences, for example, the fingerprint data of the same fingerprint of the user may be different in cases of the finger being dry and wet, leading to a result that the user's request is rejected since the real fingerprint is regarded as a fake fingerprint, and the user needs to input the fingerprint as the password again. In some cases, the user may need to input the fingerprint for many times, that is, the probability of unsuccessful recognition of a real legitimate user is high, which may reduce the user experience. In the related arts, a technical solution to solve these problems is mainly to optimize the fingerprint matching algorithm. However, the precondition of the solution is that the collected fingerprint data is complete and accurate, and for different states of the collected fingerprint data and the stored fingerprint data, the solution does not work very well.

### SUMMARY

The present disclosure aims to solve at least one of the above problems to some extent.

A main objective of the present disclosure is to provide an identity authentication method.

Another objective of the present disclosure is to provide an identity authentication system.

In order to achieve the above objectives, technical solutions of the present disclosure are realized in following manners.

Embodiments of the present disclosure provide an identity authentication method. The method may include: establishing, by a first device, a communication connection with a second device; receiving, by the first device, data to be authenticated transmitted by the second device via the communication connection, the data to be authenticated including digital authentication information and an identity identifier; collecting, by the first device, biological characteristic information; sending, by the first device, the data to be authenticated and the biological characteristic information to a background server; receiving, by the background server, the data to be authenticated and the biological characteristic information; obtaining, by the background server, a pre-stored authentication factor and biological characteristic verification information corresponding to the identity identifier; performing, by the background server, an authentication on the digital authentication information according to the authentication factor, and determining whether a matching rate between the biological characteristic information and the biological characteristic verification information is greater than a first preset value; and when the authentication performed on the digital authentication information is passed and the matching rate between the biological characteristic information and the biological characteristic verification information is greater than the first preset value, determining that an identity authentication for the second device is passed.

Embodiments of the present disclosure provide an identity authentication system. The system may include: a first device and a background server, in which the first device is configured to: establish a communication connection with a second device; receive data to be authenticated transmitted by the second device via the communication connection, the data to be authenticated including digital authentication information and an identity identifier; collect biological characteristic information of a biological limb; and send the data to be authenticated and the biological characteristic information to the background server; and the background server is configured to: receive the data to be authenticated and the biological characteristic information; obtain a pre-stored authentication factor and biological characteristic verification information corresponding to the identity identifier; perform an authentication on the digital authentication information according to the authentication factor, and determine whether a matching rate between the biological characteristic information and the biological characteristic verification information is greater than a first preset value, the first preset value being smaller than a second preset value, the second preset value referring to a matching rate indicating that two pieces of biological characteristic information are identical; and when the authentication performed on the digital authentication information is passed and the matching rate between the biological characteristic information and the biological characteristic verification information is greater than the first preset value, determine that an identity authentication for the second device is passed.

Specific embodiments of the present disclosure will be described in detail with reference to the drawings in followings. The above and other objectives, advantages and features of the present disclosure will become apparent to those skilled in the art.

### BRIEF DESCRIPTION OF THE DRAWINGS

Some specific embodiments of the present disclosure will be described in detail in an exemplary but nonrestrictive manner with reference to the drawings. The same reference numbers in the drawings identify the same or similar components or parts. Those skilled in the art should understand that the drawings are not necessarily drawn to scale. In the drawing:

FIG. 1 is a flowchart of an identity authentication method according to Embodiment 1 of the present disclosure; and

FIG. 2 is a schematic structural diagram of an identity authentication system according to Embodiment 2 of the present disclosure.

### DETAILED DESCRIPTION

### Embodiment 1

This embodiment provides an identity authentication method.

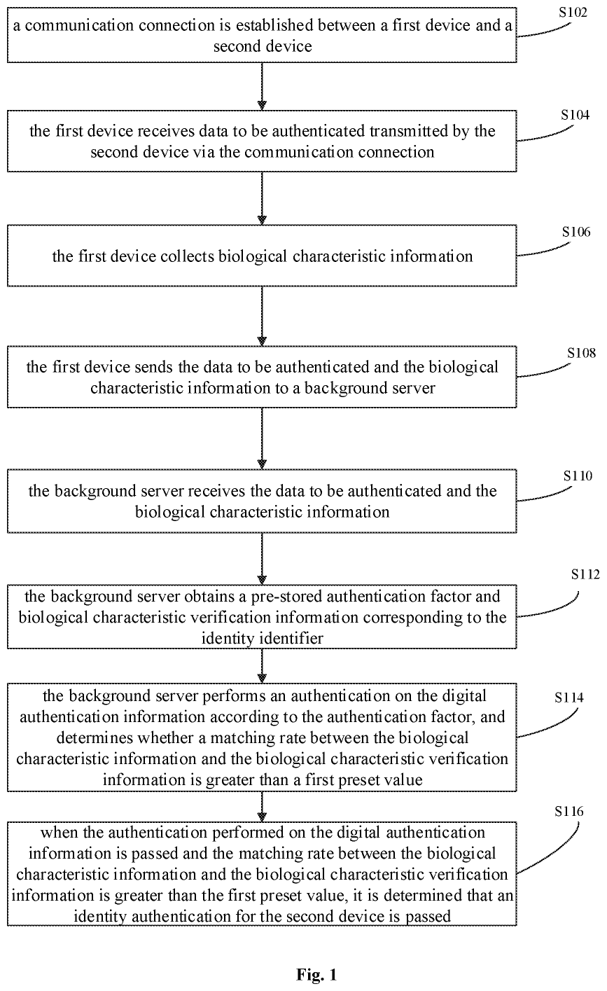

FIG. 1 is a flowchart of an identity authentication method according to this embodiment of the present disclosure. As illustrated in FIG. 1, the method mainly includes acts in blocks S102-S116.

At block S102, a communication connection is established between a first device and the second device.

In this embodiment, the first device may be connected in a wireless or wired manner such as NFC, Bluetooth, and the like.

In an alternative implementation of the embodiment of the present disclosure, the first device may establish a communication connection with a second device via the biological limb in a wireless or wired manner, that is, the first device establishes the communication connection with the second device via an intra-body communication (IBC). The biological limb includes but is not limited to a human body. For example, the first device may be a POS machine, a scanning terminal installing an Alipay application, etc., a mobile terminal, a PDA, a desktop, a notebook, an access control, etc., and the second device may be a device implanted in the human body or worn on the human body. The device implanted in the human body may be, for example, a blood flow sensor, a pulse sensor, a body temperature sensor and the like, and the device worn on the human body may be wearable electronic devices such as a wristband, a wristwatch, a necklace, a ring, a belt and the like.

In an alternative implementation of the present disclosure, the first device may establish the communication connection with the second device in following manners: when the first device detects that the biological limb is in contact with the first device and a distance between the biological limb and the second device is within a preset range, the first device may establish the communication connection with the second device via a biological limb. For example, when it is detected that a finger of a human body wearing a wristband touches the first device, the first device establishes the communication connection with the wristband via the human body.

In this embodiment, the second device may be worn on the user's body or placed in the user's body, or loaded in the clothing or accessories worn by the user, such that the second device may be communicatively connected to the first device. For example, the second device may be on the user's wrist or placed in the pocket of the user's clothing, and when the user's identity needs to be authenticated, such as, when logging in to a network, opening a door having a access control and performing a payment operation, the user may access to the first device (i.e., the verifying device) via his/her own limb (such as the arm, face). When the limb approaches the first device a certain distance (e.g., a few millimeters), the first device establishes a communication connection with a second device via the user's limb. Since the intra-body communication is performed in a certain range like 3 to 5 meters, the intra-body communication connection can be established only when the human body enters the preset range of the first device.

As an alternative implementation in this embodiment, the first device may establish the communication connection with the second device via a biological limb in a wired or wireless manner. For example, the first device and the second device may be communicated at least in the following two manners.

Wired Manner:

The first device and the second device are each provided with an electrode. When the first device is in contact with the biological limb (the human body) implanting or wearing the second device (for example, when the user wearing the wristwatch uses his/her finger to touch the POS machine), the human body is used as a conductor, and the electrodes of both sides are connected to form a path in the human body, i.e., the so-called communication connection in the wired manner. In this manner, the first device needs to be in contact with the human body wearing the second device.

Wireless Manner:

In the wireless manner, the first device and the second device (such as a POS machine and a wristwatch) may both detect whether the surrounding electric field changes. If the other party enters the range allowing the intra-body communication, the change of the field strength may be detected, and the communication connection may be established. Specifically, taking the second device as an example, the second device is worn on or built in the human body, and the oscillation of the transmitter of the second device causes the body to generate an electric field. When the distance between the second device and the first device is within the range allowing the intra-body communication, the receiver of the first device detects a change in the electric field, such that the communication connection is established between the first device and the second device. In this manner, the first device does not need to be in contact with the human body wearing the second device.

The above method utilizes the human body as a transmission medium of an electrical signal to realize information interaction among the body surface, the body, and the surrounding of the human body (3 to 5 meters). Compared to the traditional wireless communication technology such as Bluetooth, WIFI, RF, infrared and the like, signals are transmitted through the human body during the intra-body communication, the electromagnetic noise has little effect on the communication, and this manner has advantages such as low power consumption, high confidentiality and low human damage. In addition, there is no problem of low efficiency of multi-person communication, and the redundant connection problem of the wired communication method may be avoided.

At block S104, the first device receives data to be authenticated transmitted by the second device via the communication connection, in which the data to be authenticated may include digital authentication information and an identity identifier.

In this embodiment, the digital authentication information may include at least one of the following: signature information, encrypted information, and a dynamic password.

Electronic signature information may be a signature information obtained by digital sign performed on the data to be signed using a signature private key (which may be a signature private key of the second device or a private key of a security device (for example, KEY) connected to the second device. When performing the authentication on the signature information, a signature public key corresponding to the signature private key is obtained, and a signature verification is performed on the electronic signature information using the signature public key. If the signature verification is passed, the authentication is passed. The data to be signed may be the above-mentioned identity identifier, or may be a random number generated by the second device or the security device connected to the second device. In this case, the data to be authenticated may further include the random number generated by the second device. In addition, the data to be signed may also be a random number generated by the first device. In this case, the first device may send a verification request to the second device after establishing a communication connection with the second device. The request carries the random number generated by the first device, and the second device signs the random number using the signature private key after receiving the random number, so as to obtain the above signature information, and uses the random number as the data to be signed, which can prevent from a replay attack. In this alternative embodiment, the digital authentication information is the signature information, such that the identity of the user of the second device can be ensured when performing the authentication.

The encrypted information may be a MAC value obtained by calculating the data to be encrypted by the second device using a symmetric secret key obtained by negotiating with the first device, and when performing the authentication on the encrypted information, the verified MAC value is obtained by calculating the data to be encrypted using the symmetric secret key, and the encrypted information is compared with the verified MAC value, if the encrypted information is in conformity with the verified MAC value, the authentication is passed. Alternatively, the encrypted information may be ciphertext information obtained by calculating the data to be encrypted by the second device using a symmetric secret key obtained by negotiating with the first device, and when performing the authentication on the encrypted information, the ciphertext data is decrypted by using the symmetric secret key, and the information obtained by the decryption is compared with the data to be encrypted. If the information obtained by the decryption is in conformity with the data to be encrypted, the authentication is passed.

The dynamic password may be a dynamic password generated based on a seed secret key. When performing the authentication on the dynamic password, a verification value is calculated using the seed secret key, the verification value is compared with the dynamic password. If the verification value is in consistent with the dynamic password, the authentication is passed. The password may be time-based or event-based, and may be a dynamic challenge code, which is not limited in this embodiment.

In this embodiment, the digital authentication information may be authenticated by any of the foregoing implementations to ensure the legitimacy of the second device.

In the above embodiment, the second device may calculate the digital authentication information by itself, or may interact with another device (for example, an electronic device having a signature function, an encryption function, or a dynamic password function) to obtain the data authentication information, which is not limited in this embodiment.

In an alternative implementation of this embodiment, the identity identifier may be a device identifier of the second device, a user ID, and the like, which may uniquely identify the identity of the user. The identity identifier may be uniquely associated with the authentication factor for the digital authentication information and the biological characteristic verification information of the second device's user, so as to perform a double verification both on the digital authentication information and the biological characteristic information. Therefore, after the double verification is passed, it can be determined that the biological characteristic information and the digital authentication information are all from the same user, and the user's legality is guaranteed.

In an alternative implementation of the embodiment, the second device may send the data to be authenticated to the first device after the communication connection is established. For example, a switch may be set on the second device, and after the user turns on the switch, the second device starts to broadcast the data to be authenticated. After the first device establishes the communication connection with the second device, the first device receives the data to be authenticated broadcasted by the second device, or the second device may actively detect whether the communication connection is established with the first device, and if yes, the second device actively sends the data to be authenticated to the first device. With this implementation, the process may be simplified and the authenticated speed may be improved.

In another alternative implementation of the embodiment of the present disclosure, the second device may send the data to be authenticated after receiving the request of the first device. In this alternative implementation, the first device may send an authentication request to the second device after establishing a communication connection with a second device, and the second device sends the data to be authenticated to the first device in response to the authentication request after receiving the authentication request. For example, in a payment process, the first device may send the authentication request carrying transaction information to the second device, and after receiving the authentication request, the second device sends the data to be authenticated to the first device in response to the authentication request. The second device may extract key information from the transaction information and display the key information after receiving the transaction information, and after receiving the user confirmation, a to-be-authenticated request is sent to the first device to ensure the security of the transaction. In addition, in the alternative implementation, the authentication request may further carry the to-be-calculated information such as the random number etc. determined by the first device, and after receiving the authentication request, the second device may sign or encrypt the to-be-calculated information or generate the dynamic password according to the to-be-calculated information.

At block S106, the first device collects biological characteristic information.

The biological characteristic information includes at least one of the following: fingerprint information, iris information, face information, and vein information. In this embodiment, the first device collects biometric information of the biological limb when the first device approaches the biological limb in close contact with the second device. For example, in a short time period (e.g., 3 second) of the user's finger touching the touch component of the POS machine, the touch component of the POS machine collects fingerprint information. For another example, during a time period of establishing the intra-body communication connection between the user's wristwatch and the Alipay payment terminal (the payment terminal has a photographing function, which can be used to collect the face information), the face information is collected by the payment terminal.

In this step, in particular, in a case of the biological characteristic information including the fingerprint information and/or the vein information, the biological limb needs to touch the first device to collect the biological characteristic information. As an alternative implementation, collecting the biological characteristic information of the biological limb may include: collecting the biological characteristic information of the part of the biological limb touching the first device when the biological limb touches the first device. For example, the user's finger touches a fingerprint collection portion of the first device, or the user's wrist touches a vein information collection portion of the first device. With this alternative implementation, since the user's limb needs to touch the first device to collect the biological characteristic information, such that the current authentication is permitted by the user, thereby avoiding a situation that the authentication process is triggered caused by an inadvertent proximity between the first device and the second device.

At block S108, the first device sends the data to be authenticated and the biological characteristic information to a background server.

At block S110, the background server receives the data to be authenticated and the biological characteristic information.

At block S112, the background server obtains a pre-stored authentication factor and biological characteristic verification information corresponding to the identity identifier.

In this embodiment, the background server pre-stores the user's authentication factor and biological characteristic verification information according to the identity identifier (of the second device, or of the user of the second device, or of a security device connected to the second device (e.g., KEY, a dynamic port token, etc.) when, for example, registering the second device or the security device connected to the second device or allocating the second device or the security device connected to the second device to the user, which will not be limited in this embodiment.

At block S114, the background server performs an authentication on the digital authentication information according to the authentication factor, and determines whether a matching rate between the biological characteristic information and the biological characteristic verification information is greater than a first preset value.

In this embodiment, the background server obtains the authentication factor and the biological characteristic verification information according to the authentication identifier information, and uses the authentication factor and the biological characteristic verification information to authenticate the digital authentication information and the biological characteristic information. The authentication factor and the biological characteristic verification information are uniquely associated with authentication identification information. Therefore, the authentication factor and the biological characteristic verification information corresponding to the user can be uniquely queried according to the authentication identification information, such that the digital authentication information and the legitimacy of the user may be guaranteed after the double authentication is passed using the digital authentication information and the biological characteristic information.

In this step, the manner of the background server authenticating the digital authentication information by using the authentication factor is related to a specific form of using the digital authentication information. For example, if the digital authentication information is to sign the data to be signed using a signature private key (which may be a private key of the second device, or a private key of the security device (for example, KEY) connected to the second device) to obtain the signature information, the authentication factor is a signature public key corresponding to the signature private key. When performing the authentication on the digital authentication information, the data to be signed is calculated by using the signature public key to obtain a signature verification value, and the signature verification value is compared with the received signature information. If the signature verification value is in conformity with the received signature information, the authentication is passed; otherwise, the authentication fails. If the digital authentication information is to encrypt the information to be encrypted using the symmetric secret key to obtain the encrypted information, the authentication factor is the symmetric secret key, and when performing the authentication on the digital authentication information, the symmetric secret key is used to encrypt the information to be encrypted, the encrypted verification information obtained after the encryption is compared with the received encrypted information. If the encrypted verification information obtained after the encryption is in conformity with the received encrypted information, the authentication is passed; otherwise, the authentication fails. Alternatively, the received encrypted information may be decrypted by using the symmetric secret key, and the decrypted plaintext information is compared with the information to be encrypted. If the decrypted plaintext information is in conformity with the information to be encrypted, the authentication is passed; otherwise, the authentication fails. In the case of the digital authentication information being the dynamic password, the authentication factor is a seed secret key for verifying the dynamic password. When performing the authentication on the digital authentication information, the seed secret key is used to generate the dynamic password, and the generated dynamic password is compared with the received dynamic password. If the generated dynamic password is in conformity with the received dynamic password, the authentication is passed; otherwise, the authentication fails.

In this embodiment, the first preset value indicating the matching rate between the biological characteristic information and the biological characteristic verification information is smaller than the matching rate (i.e., the second preset value) indicating whether two pieces of biological characteristic information is the same biological characteristic information in the actual application. For example, suppose that in actual existing application, when the matching rate of two pieces of fingerprint information reaches 99% (that is, the ratio indicating that the two pieces of fingerprint information are the same), the two pieces of fingerprint information are considered to be the fingerprint information of the same fingerprint (i.e., the second preset value is 99%); otherwise, the two pieces of fingerprint information are not the fingerprint information of the same fingerprint. However, the first preset value in this embodiment may be 80%, that is, it is determined whether the matching rate between the received biological characteristic information and the biological characteristic verification information reaches 80% instead of 99%.

At block S116, when the authentication performed on the digital authentication information is passed and the matching rate between the biological characteristic information and the biological characteristic verification information is greater than the first preset value, it is determined that an identity authentication for the second device is passed.

In an alternative implementation of the embodiment of the present disclosure, the background server may also return the authentication result to the first device. In addition, after the identity authentication of the second device is passed, the background server may perform subsequent operations such as granting the second device authorization, opening the door having an access control, etc., or performing the payment process in the payment process, which will not be limited in this embodiment.

There may be a probability of unsuccessful recognition of a real legitimate user using the biological characteristic information authentication technology in the prior art. Taking fingerprint recognition as an example, in many cases, the user's fingerprint is real but the background system identifying error occurs, mistakenly identifying the user's fingerprint as a fake fingerprint, and thus failing to pass the authentication, and the payment transaction cannot be realized; while sometimes, the fingerprint of the illegal user is fake but is also authenticated by the background system, causing economic losses for the legitimate user. These situations occur for a high probability. However, in this embodiment, the double authentication performed on the digital authentication information and the biological characteristic information may prevent from the situation where some illegal users are successfully identified, and can reduce the probability of the situation of unsuccessful recognition of real legitimate user. Firstly, by the above three methods for authenticating the digital authentication information, it can be determined that the user is a legitimate user, and if the user is an illegal user, the digital authentication cannot be passed, then the operation of the fake fingerprint authentication does not occur, thereby prevent from the situation where some illegal users are successfully identified. Secondly, in the case of ensuring that the user is a legitimate user, the background can reduce the similarity criterion of the matching the two pieces of biometric information, so as to reduce the probability of unsuccessful recognition of real legitimate user. For example, theoretically, in order to make the two pieces of biometric information being matched completely, the similarity should reach at least 99% (the second preset value). If the background finds out that the similarity is only 90%, it will be identified as mismatch and the authentication will not be passed, leading to the case where the real fingerprint is recognized as a fake fingerprint. In the present disclosure, since the digital authentication has ensured that the user is a legitimate user, the similarity for perfectly matching can be reduced to 80% (the first preset value), which means that it is considered to be successfully matching as long as the similarity reaches 80% (the first preset value). Therefore, when the similarity of the two pieces of biometric information is 90%, the authentication can be passed, thereby avoiding the situation of unsuccessful recognition of real legitimate user, such that the probability of unsuccessful recognition of real legitimate user in the biological characteristic information authentication technology may be reduced.

With the identity authentication method provided by the embodiment of the present disclosure, the background server performs the double authentication on the digital authentication information and the biological characteristic information, the probability of unsuccessful recognition of real legitimate user may be reduced and the user experience may be improved.

### Embodiment 2

This embodiment provides an identity authentication system. The system is configured to perform the method provided in Embodiment 1.

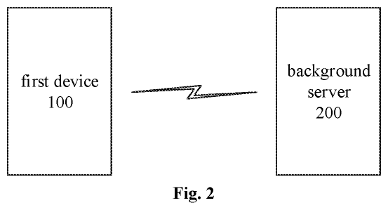

FIG. 2 is a schematic structural diagram of an identity authentication system according to this embodiment. As illustrated in FIG. 2, the system mainly includes: a first device 100 and a background server 200.

In this embodiment, the first device 100 is configured to: establish a communication connection with a second device; receive data to be authenticated transmitted by the second device via the communication connection, the data to be authenticated including digital authentication information and an identity identifier; collect biological characteristic information of a biological limb when the biological limb enters a preset range of the first device 100; and send the data to be authenticated and the biological characteristic information to the background server 200.

The background server 200 is configured to: receive the data to be authenticated and the biological characteristic information; obtain a pre-stored authentication factor and biological characteristic verification information corresponding to the identity identifier; perform an authentication on the digital authentication information according to the authentication factor, and determine whether a matching rate between the biological characteristic information and the biological characteristic verification information is greater than a first preset value; and when the authentication performed on the digital authentication information is passed and the matching rate between the biological characteristic information and the biological characteristic verification information is greater than the first preset value, determine that an identity authentication for the second device is passed. The first preset value is smaller than a second preset value, and the second preset value refers to a matching rate indicating that two pieces of biological characteristic information are identical.

In an alternative implementation of the embodiment of the present disclosure, the first device 100 may establish the communication connection with the second device via a biological limb. For example, the first device 100 may be a POS machine, a scanning terminal installing an Alipay application, etc., a mobile terminal, a PDA, a desktop, a notebook, an access control, etc., and the second device may be a device implanted in the human body or worn on the human body. The device implanted in the human body may be, for example, a blood flow sensor, a pulse sensor, a body temperature sensor and the like, and the device worn on the human body may be wearable electronic devices such as a wristband, a wristwatch, a necklace, a ring, a belt and the like.

In an alternative implementation of the present disclosure, the first device 100 may establish the communication connection with the second device in following manners: when the first device 100 detects that the biological limb is in contact with the first device 100 and a distance between the biological limb and the second device is within a preset range, the first device may establish the communication connection with the second device via a biological limb. For example, when it is detected that a finger of a human body wearing a wristband touches the first device 100, the first device establishes the communication connection with the wristband via the human body.

In this embodiment, the second device may be worn on the user's body or placed in the user's body, or loaded in the clothing or accessories worn by the user, such that the second device may be communicatively connected to the first device. For example, the second device may be on the user's wrist or placed in the pocket of the user's clothing, and when the user's identity needs to be authenticated, such as, when logging in to a network, opening a door having an access control and performing a payment operation, the user may access to the first device 100 (i.e., the verifying device) via his/her own limb (such as the arm, face). When the limb approaches the first device 100 a certain distance (e.g., a few millimeters), the first device 100 establishes a communication connection with a second device via the user's limb. Since the intra-body communication is performed in a certain range like 3 to 5 meters, the intra-body communication connection can be established only when the human body enters the preset range of the first device 100.

As an alternative implementation in this embodiment, the first device 100 may establish the communication connection with the second device via a biological limb in a wired or wireless manner. For example, the first device 100 and the second device may be communicated at least in the following two manners.

Wired Manner:

The first device 100 and the second device are each provided with an electrode. When the first device 100 is in contact with the biological limb (the human body) implanting or wearing the second device (for example, when the user wearing the wristwatch uses his/her finger to touch the POS machine), the human body is used as a conductor, and the electrodes of both sides are connected to form a path in the human body, i.e., the so-called communication connection in the wired manner. In this manner, the first device 100 needs to be in contact with the human body wearing the second device.

Wireless Manner:

In the wireless manner, the first device 100 and the second device (such as a POS machine and a wristwatch) may both detect whether the surrounding electric field changes. If the other party enters the range allowing the intra-body communication, the change of the field strength may be detected, and the communication connection may be established. Specifically, taking the second device as an example, the second device is worn on or built in the human body, and the oscillation of the transmitter of the second device causes the body to generate an electric field. When the distance between the second device and the first device 100 is within the range allowing the intra-body communication, the receiver of the first device 100 detects a change in the electric field, such that the communication connection is established between the first device and the second device. In this manner, the first device 100 does not need to be in contact with the human body wearing the second device.

The above method utilizes the human body as a transmission medium of an electrical signal to realize information interaction among the body surface, the body, and the surrounding of the human body (3 to 5 meters). Compared to the traditional wireless communication technology such as Bluetooth, WIFI, RF, infrared and the like, signals are transmitted through the human body during the intra-body communication, the electromagnetic noise has little effect on the communication, and this manner has advantages such as low power consumption, high confidentiality and low human damage. In addition, there is no problem of low efficiency of multi-person communication, and the redundant connection problem of the wired communication method may be avoided.

In an alternative implementation of this embodiment, the identity identifier may be a device identifier of the second device, a user ID, and the like, which may uniquely identify the identity of the user, and the identity identifier may be uniquely associated with the second user to authenticate the authentication factor of the digital authentication information and the biological characteristic verification information are used to perform a double verification on the digital authentication information and the biological characteristic information. Therefore, after the double verification is passed, it can be determined that the biological characteristic information and the digital authentication information are all from the same user, and the user's legality is guaranteed.

In an alternative implementation of the embodiment, the second device may actively send the data to be authenticated to the first device after the communication connection is established. In this alternative implementation, the first device 100 may receive the data to be authenticated transmitted by the second device in following manners. The first device 100 receives the data to be authenticated transmitted by the second device via the communication connection. For example, a switch may be set on the second device, and after the user turns on the switch, the second device starts to broadcast the data to be authenticated. After the first device 100 establishes the communication connection with the second device, the first device 100 receives the data to be authenticated broadcasted by the second device, or the second device may actively detect whether the communication connection is established with the first device 100, and if yes, the second device actively sends the data to be authenticated to the first device 100. With this implementation, the process may be simplified and the authenticated speed may be improved.

In another alternative implementation of the embodiment of the present disclosure, the second device may also send the data to be authenticated after receiving the request of the first device 100. In this alternative implementation, the first device 100 may receive the data to be authenticated transmitted by the second device in following manner. The first device 100 may send an authentication request to the second device via the communication connection, and receive the data to be authenticated sent by the second device in response to the authentication request via the communication connection. For example, in a payment process, the first device 100 may send the authentication request carrying transaction information to the second device, and after receiving the authentication request, the second device sends the data to be authenticated to the first device 100 in response to the authentication request. The second device may extract key information from the transaction information and display the key information after receiving the transaction information, and after receiving the user confirmation, a to-be-authenticated request is sent to the first device 100 to ensure the security of the transaction. In addition, in this alternative implementation, the authentication request may further carry the to-be-calculated information such as the random number etc. determined by the first device 100, and after receiving the authentication request, the second device may sign or encrypt the to-be-calculated information or generate the dynamic password for the to-be-calculated information.

The biological characteristic information includes at least one of the following: fingerprint information, iris information, face information, and vein information. In this embodiment, the first device 100 collects biometric information of the biological limb when the first device approaches the biological limb in close contact with the second device. For example, in a short time period (e.g., 3 second) of the user's finger touching the touch component of the POS machine, the touch component of the POS machine collects fingerprint information. For another example, when the user's wristwatch approaches to the Alipay payment terminal (the payment terminal has a photographing function, which can be used to collect the face information) in a certain distance, the face information is collected by the payment terminal.

In an alternative implementation of the embodiment of the present disclosure, the biological characteristic information may include: the fingerprint information and/or the vein information. In this alternative implementation, the first device 100 collects the biological characteristic information of the biological limb in following manner. The biological characteristic information of the part of the biological limb in contact with the first device 100 is collected when the biological limb is in contact with the first device 100. For example, the user's finger contacts a fingerprint collection portion of the first device 100, or the user's wrist contacts a vein information collection portion of the first device 100. With this alternative implementation, since the user's limb needs to be in contact to the first device 100 to collect the biological characteristic information, the current authentication can be kept for the user, thereby avoiding a situation that the authentication process is triggered caused by an inadvertent proximity between the first device 100 and the second device.

In this embodiment, the background server 200 pre-stores the user's authentication factor and biological characteristic verification information according to the identity identifier (of the second device, or of the user of the second device, or of a security device connected to the second device (e.g., KEY, a dynamic port token, etc.) when, for example, registering the second device or the security device connected to the second device or allocating the second device or the security device connected to the second device to the user, which will not be limited in this embodiment.

In this embodiment, the background server 200 obtains the authentication factor and the biological characteristic verification information according to the authentication identifier information, and uses the authentication factor and the biological characteristic verification information to authenticate the digital authentication information and the biological characteristic information. The authentication factor and the biological characteristic verification information are uniquely associated with authentication identification information. Therefore, the authentication factor and the biological characteristic verification information corresponding to the user can be uniquely queried according to the authentication identification information, such that the digital authentication information and the legitimacy of the user may be guaranteed after the double authentication is passed using the digital authentication information and the biological characteristic information.

In an alternative implementation of the embodiment of the present disclosure, the digital authentication information includes: signature information obtained by digital sign performed on data to be signed using a signature private key; the authentication factor includes: a signature public key corresponding to the signature private key; the background server 200 may perform the authentication on the digital authentication information according to the authentication factor in following manners. The background server 200 performs a signature authentication on the signature information using the signature public key and the data to be signed. In other words, when performing the authentication on the digital authentication information, the background server 200 computes the data to be signed using the signature public key to obtain a signature verification value, and the signature verification value is compared with the received signature information. If the signature verification value is in conformity with the received signature information, the authentication is passed; otherwise, the authentication fails.

In another alternative implementation of the embodiment of the present disclosure, the digital authentication information includes: encrypted information obtained by encrypting information to be encrypted using a symmetric secret key; the authentication factor includes: the symmetric secret key; and the background server 200 performs the authentication on the digital authentication information according to the authentication factor in following manners. The background server 200 performs the authentication on the encrypted information using the symmetric secret key and the information to be encrypted. In other words, when the background server 200 performs the authentication on the digital authentication information, the symmetric secret key is used to encrypt the information to be encrypted, the encrypted verification information obtained after the encryption is compared with the received encrypted information. If the encrypted verification information obtained after the encryption is in conformity with the received encrypted information, the authentication is passed; otherwise, the authentication fails. Alternatively, the received encrypted information may be decrypted by using the symmetric secret key, and the decrypted plaintext information is compared with the information to be encrypted. If the decrypted plaintext information is in conformity with the information to be encrypted, the authentication is passed; otherwise, the authentication fails.

In yet another alternative implementation of the embodiment of the present disclosure, the digital authentication information includes: a dynamic password; the authentication factor includes: a seed secret key for verifying the dynamic password. The background server 200 performs the authentication on the digital authentication information according to the authentication factor in following manners. In other words, when the background server 200 performs the authentication on the digital authentication information, the seed secret key is used to generate the dynamic password, and the generated dynamic password is compared with the received dynamic password. If the generated dynamic password is in conformity with the received dynamic password, the authentication is passed; otherwise, the authentication fails.

In this embodiment, the first preset value indicating the matching rate between the biological characteristic information and the biological characteristic verification information is smaller than the matching rate (i.e., the second preset value) indicating whether two pieces of biological characteristic information is the same biological characteristic information in the actual application. For example, suppose that in actual application, when the matching rate of two pieces of fingerprint information reaches 99% (that is, the ratio indicating that the two pieces of fingerprint information are the same), the two pieces of fingerprint information are considered to be the fingerprint information of the same fingerprint (i.e., the second preset value is 99%); otherwise, the two pieces of fingerprint information are not the fingerprint information of the same fingerprint. The first preset value in this embodiment may be 80%, that is, it is determined whether the matching rate between the received biological characteristic information and the biological characteristic verification information reaches 80% instead of 99%.

There may be a probability of unsuccessful recognition of a real legitimate user using the biological characteristic information authentication technology in the prior art. Taking fingerprint recognition as an example, in many cases, the user's fingerprint is real but the background system identifying error occurs, mistakenly identifying the user's fingerprint as a fake fingerprint, and thus failing to pass the authentication, and the payment transaction cannot be realized; while sometimes, the fingerprint of the illegal user is fake but is also authenticated by the background system, causing economic losses for the legitimate user. These situations occur for a high probability. However, in this embodiment, the double authentication performed on the digital authentication information and the biological characteristic information may prevent from the situation where some illegal users are successfully identified, and can reduce the probability of the situation of unsuccessful recognition of real legitimate user. Firstly, by the above three methods for authenticating the digital authentication information, it can be determined that the user is a legitimate user, and if the user is an illegal user, the digital authentication cannot be passed, then the operation of the fake fingerprint authentication does not occur, thereby prevent from the situation where some illegal users are successfully identified. Secondly, in the case of ensuring that the user is a legitimate user, the background can reduce the similarity criterion of the matching the two pieces of biometric information, so as to reduce the probability of unsuccessful recognition of real legitimate user. For example, theoretically, in order to make the two pieces of biometric information being matched completely, the similarity should reach at least 99% (the second preset value). If the background finds out that the similarity is only 90%, it will be identified as mismatch and the authentication will not be passed, leading to the case where the real fingerprint is recognized as a fake fingerprint. In the present disclosure, since the digital authentication has ensured that the user is a legitimate user, the similarity for perfectly matching can be reduced to 80% (the first preset value), which means that it is considered to be successfully matching as long as the similarity reaches 80% (the first preset value). Therefore, when the similarity of the two pieces of biometric information is 90%, the authentication can be passed, thereby avoiding the situation of unsuccessful recognition of real legitimate user, such that the probability of unsuccessful recognition of real legitimate user in the biological characteristic information authentication technology may be reduced.

With the identity authentication system provided by the embodiment of the present disclosure, the background server 200 performs the double authentication on the digital authentication information and the biological characteristic information, the probability of unsuccessful recognition of real legitimate user may be reduced and the user experience may be improved.

Embodiments of the present disclosure also provides a computer program, when the computer program is run on a processor, the above identity authentication method is performed.

Numerous specific details are described in the specification provided herein. However, it should be understood that the embodiments of the disclosure may be practiced without these specific details. In some examples, well-known methods, structures, and techniques are not illustrated in detail so as not to obscure the understanding of the specification.

Similarly, it should be understood that, in order to simplify the present disclosure and to assist in understanding one or more of the various inventive aspects, in the above description of the exemplary embodiments of the present disclosure, various features of the present disclosure are sometimes grouped together into a single embodiment, figure, or description thereof. However, the method disclosed is not to be interpreted as reflecting the intention that the claimed invention requires more features than those recited in the claims. In more details, as the following claims reflect, inventive aspects reside in less than all features of the single embodiments disclosed herein. Therefore, the claims following the specific embodiments are hereby explicitly incorporated into the specific embodiments, and each of the claims is regarded as a separate embodiment of the disclosure.

Those skilled in the art will appreciate that the modules in the devices of the embodiments may be adaptively changed and placed in one or more devices different from the embodiment. The modules or units or components in the embodiments may be combined into one module or unit or component, or may be divided into a plurality of sub-modules or sub-units or sub-components. In addition to at least some of such features and/or the processes or units being mutually exclusive, all combinations of the features disclosed in this specification, as well as any methods or devices so disclosed, may be combined in any combination. Each feature disclosed in this specification can be replaced by an alternative feature that provides the same, equivalent or similar purpose, unless stated otherwise.

The various component embodiments of the present disclosure may be implemented in hardware, or in a software module running on one or more processors, or in a combination thereof.

Therefore, those skilled in the art will recognize that although a plurality of exemplary embodiments have been shown and described in detail herein, many other variations or modifications in conformity of the principles of the disclosure may be determined or derived directly in accordance with the content disclosed by the present disclosure. Therefore, the scope of the present disclosure should be understood and construed as covering all such other verifications or modifications.

1. An identity authentication method, comprising:
establishing, by a first device, a communication connection with a second device;
receiving, by the first device, data to be authenticated transmitted by the second device via the communication connection, the data to be authenticated comprising digital authentication information and an identity identifier;
collecting, by the first device, biological characteristic information;
sending, by the first device, the data to be authenticated and the biological characteristic information to a background server;
receiving, by the background server, the data to be authenticated and the biological characteristic information;
obtaining, by the background server, a pre-stored authentication factor and biological characteristic verification information corresponding to the identity identifier;
performing, by the background server, an authentication on the digital authentication information according to the authentication factor, and determining whether a matching rate between the biological characteristic information and the biological characteristic verification information is greater than a first preset value, the first preset value being smaller than a second preset value, the second preset value referring to a matching rate indicating that two pieces of biological characteristic information are identical; and
when the authentication performed on the digital authentication information is passed and the matching rate between the biological characteristic information and the biological characteristic verification information is greater than the first preset value, determining that an identity authentication for the second device is passed.

2. The method according to claim 1, wherein the biological characteristic information comprises at least one of: fingerprint information and vein information; and
collecting, by the first device, the biological characteristic information comprises: when a biological limb is in contact with the first device, collecting the biological characteristic information of a portion of the biological limb in contact with the first device.

3. The method according to claim 1, wherein receiving, by the first device, the data to be authenticated transmitted by the second device via the communication connection comprises at least one of:
receiving, by the first device, the data to be authenticated broadcast by the second device via the communication connection; and
sending, by the first device, an authentication request to the second device via the communication connection; and receiving, by the first device, the data to be authenticated transmitted by the second device in response to the authentication request via the communication connection.

4. The method according to claim 1, wherein the digital authentication information comprises at least one of: signature information obtained by digital sign performed on data to be signed using a signature private key, encrypted information obtained by encrypting information to be encrypted using a symmetric secret key, and a dynamic password;
when the digital authentication information comprises the signature information obtained by digital sign performed on the data to be signed using the signature private key, the authentication factor comprises: a signature public key corresponding to the signature private key; and performing, by the background server, the authentication on the digital authentication information according to the authentication factor comprises: performing, by the background server, a signature authentication on the signature information using the signature public key and the data to be signed;
when the digital authentication information comprises the encrypted information obtained by encrypting the information to be encrypted using the symmetric secret key, the authentication factor comprises: the symmetric secret key; and performing, by the background server, the authentication on the digital authentication information according to the authentication factor comprises: performing, by the background server, the authentication on the encrypted information using the symmetric secret key and the information to be encrypted; and
when the digital authentication information comprises the dynamic password, the authentication factor comprises: a seed secret key for verifying the dynamic password; and performing, by the background server, the authentication on the digital authentication information according to the authentication factor comprises: performing, by the background server, the authentication on the dynamic password at least using the seed secret key.

5. The method according to claim 1, wherein establishing, by the first device, the communication connection with the second device comprises:
establishing, by the first device, the communication connection with the second device via a biological limb.

6. An identity authentication system, comprising: a first device and a background server, wherein the first device is configured to:
establish a communication connection with a second device;
receive data to be authenticated transmitted by the second device via the communication connection, the data to be authenticated comprising digital authentication information and an identity identifier;
collect biological characteristic information of a biological limb; and
send the data to be authenticated and the biological characteristic information to the background server;
the background server is configured to:
receive the data to be authenticated and the biological characteristic information;
obtain a pre-stored authentication factor and biological characteristic verification information corresponding to the identity identifier;
perform an authentication on the digital authentication information according to the authentication factor, and determine whether a matching rate between the biological characteristic information and the biological characteristic verification information is greater than a first preset value, the first preset value being smaller than a second preset value, the second preset value referring to a matching rate indicating that two pieces of biological characteristic information are identical; and
when the authentication performed on the digital authentication information is passed and the matching rate between the biological characteristic information and the biological characteristic verification information is greater than the first preset value, determine that an identity authentication for the second device is passed.

7. The system according to claim 6, wherein the biological characteristic information comprises at least one of: fingerprint information and vein information; and
the first device collects the biological characteristic information by an act of: when the biological limb is in contact with the first device, collecting the biological characteristic information of a portion of the biological limb in contact with the first device.

8. The system according to claim 6, wherein the first device receives the data to be authenticated transmitted by the second device via the communication connection by at least one of:
receiving, by the first device, the data to be authenticated broadcast by the second device via the communication connection; and
sending, by the first device, an authentication request to the second device via the communication connection; and receiving, by the first device, the data to be authenticated transmitted by the second device in response to the authentication request via the communication connection.

9. The system according to claim 6, wherein the digital authentication information comprises at least one of: signature information obtained by digital sign performed on data to be signed using a signature private key, encrypted information obtained by encrypting information to be encrypted using a symmetric secret key, and a dynamic password;
when the digital authentication information comprises the signature information obtained by digital sign performed on the data to be signed using the signature private key, the authentication factor comprises: a signature public key corresponding to the signature private key, and the background server performs the authentication on the digital authentication information according to the authentication factor by an act of: performing, by the background server, a signature authentication on the signature information using the signature public key and the data to be signed;
when the digital authentication information comprises the encrypted information obtained by encrypting the information to be encrypted using the symmetric secret key, the authentication factor comprises: the symmetric secret key; and the background server performs the authentication on the digital authentication information according to the authentication factor by an act of: performing, by the background server, the authentication on the encrypted information using the symmetric secret key and the information to be encrypted; and
when the digital authentication information comprises the dynamic password, the authentication factor comprises: a seed secret key for verifying the dynamic password, and the background server performs the authentication on the digital authentication information according to the authentication factor by an act of: performing, by the background server, the authentication on the dynamic password at least using the seed secret key.

10. The system according to claim 6, wherein the first device establishes the communication connection with the second device by an act of:
establishing, by the first device, the communication connection with the second device via a biological limb.

11. A computer program, when run on a processor, configured to perform an identity authentication method, wherein the method comprises:
establishing, by a first device, a communication connection with a second device;
receiving, by the first device, data to be authenticated transmitted by the second device via the communication connection, the data to be authenticated comprising digital authentication information and an identity identifier;
collecting, by the first device, biological characteristic information;
sending, by the first device, the data to be authenticated and the biological characteristic information to a background server;
receiving, by the background server, the data to be authenticated and the biological characteristic information;
obtaining, by the background server, a pre-stored authentication factor and biological characteristic verification information corresponding to the identity identifier;
performing, by the background server, an authentication on the digital authentication information according to the authentication factor, and determining whether a matching rate between the biological characteristic information and the biological characteristic verification information is greater than a first preset value, the first preset value being smaller than a second preset value, the second preset value referring to a matching rate indicating that two pieces of biological characteristic information are identical; and
when the authentication performed on the digital authentication information is passed and the matching rate between the biological characteristic information and the biological characteristic verification information is greater than the first preset value, determining that an identity authentication for the second device is passed.

12. The method according to claim 2, wherein receiving, by the first device, the data to be authenticated transmitted by the second device via the communication connection comprises at least one of:
receiving, by the first device, the data to be authenticated broadcast by the second device via the communication connection; and
sending, by the first device, an authentication request to the second device via the communication connection; and receiving, by the first device, the data to be authenticated transmitted by the second device in response to the authentication request via the communication connection.

13. The method according to claim 2, wherein the digital authentication information comprises at least one of: signature information obtained by digital sign performed on data to be signed using a signature private key, encrypted information obtained by encrypting information to be encrypted using a symmetric secret key, and a dynamic password;
when the digital authentication information comprises the signature information obtained by digital sign performed on the data to be signed using the signature private key, the authentication factor comprises: a signature public key corresponding to the signature private key; and performing, by the background server, the authentication on the digital authentication information according to the authentication factor comprises: performing, by the background server, a signature authentication on the signature information using the signature public key and the data to be signed;
when the digital authentication information comprises the encrypted information obtained by encrypting the information to be encrypted using the symmetric secret key, the authentication factor comprises: the symmetric secret key; and performing, by the background server, the authentication on the digital authentication information according to the authentication factor comprises: performing, by the background server, the authentication on the encrypted information using the symmetric secret key and the information to be encrypted; and
when the digital authentication information comprises the dynamic password, the authentication factor comprises: a seed secret key for verifying the dynamic password; and performing, by the background server, the authentication on the digital authentication information according to the authentication factor comprises: performing, by the background server, the authentication on the dynamic password at least using the seed secret key.

14. The method according to claim 3, wherein the digital authentication information comprises at least one of: signature information obtained by digital sign performed on data to be signed using a signature private key, encrypted information obtained by encrypting information to be encrypted using a symmetric secret key, and a dynamic password;
when the digital authentication information comprises the signature information obtained by digital sign performed on the data to be signed using the signature private key, the authentication factor comprises: a signature public key corresponding to the signature private key; and performing, by the background server, the authentication on the digital authentication information according to the authentication factor comprises: performing, by the background server, a signature authentication on the signature information using the signature public key and the data to be signed;
when the digital authentication information comprises the encrypted information obtained by encrypting the information to be encrypted using the symmetric secret key, the authentication factor comprises: the symmetric secret key; and performing, by the background server, the authentication on the digital authentication information according to the authentication factor comprises: performing, by the background server, the authentication on the encrypted information using the symmetric secret key and the information to be encrypted; and
when the digital authentication information comprises the dynamic password, the authentication factor comprises: a seed secret key for verifying the dynamic password; and performing, by the background server, the authentication on the digital authentication information according to the authentication factor comprises: performing, by the background server, the authentication on the dynamic password at least using the seed secret key.

15. The method according to claim 2, wherein establishing, by the first device, the communication connection with the second device comprises:
establishing, by the first device, the communication connection with the second device via a biological limb.

16. The method according to claim 3, wherein establishing, by the first device, the communication connection with the second device comprises:
establishing, by the first device, the communication connection with the second device via a biological limb.

17. The method according to claim 4, wherein establishing, by the first device, the communication connection with the second device comprises:
establishing, by the first device, the communication connection with the second device via a biological limb.

18. The system according to claim 7, wherein the first device receives the data to be authenticated transmitted by the second device via the communication connection by at least one of:
receiving, by the first device, the data to be authenticated broadcast by the second device via the communication connection; and
sending, by the first device, an authentication request to the second device via the communication connection; and receiving, by the first device, the data to be authenticated transmitted by the second device in response to the authentication request via the communication connection.

19. The system according to claim 7, wherein the digital authentication information comprises at least one of: signature information obtained by digital sign performed on data to be signed using a signature private key, encrypted information obtained by encrypting information to be encrypted using a symmetric secret key, and a dynamic password;
when the digital authentication information comprises the signature information obtained by digital sign performed on the data to be signed using the signature private key, the authentication factor comprises: a signature public key corresponding to the signature private key, and the background server performs the authentication on the digital authentication information according to the authentication factor by an act of: performing, by the background server, a signature authentication on the signature information using the signature public key and the data to be signed;
when the digital authentication information comprises the encrypted information obtained by encrypting the information to be encrypted using the symmetric secret key, the authentication factor comprises: the symmetric secret key; and the background server performs the authentication on the digital authentication information according to the authentication factor by an act of: performing, by the background server, the authentication on the encrypted information using the symmetric secret key and the information to be encrypted; and
when the digital authentication information comprises the dynamic password, the authentication factor comprises: a seed secret key for verifying the dynamic password, and the background server performs the authentication on the digital authentication information according to the authentication factor by an act of: performing, by the background server, the authentication on the dynamic password at least using the seed secret key.

20. The system according to claim 7, wherein the first device establishes the communication connection with the second device by an act of:
establishing, by the first device, the communication connection with the second device via a biological limb.
